(19) United States
(12) Patent Application Publication
(10) Pub. No.: US 2013/0294638 A1
(43) Pub. Date: Nov. 7, 2013

(54) SPEAKER TOWER

(71) Applicants: Jorn Huseby, Camarillo, CA (US); Bradley Pfeifer, Carmarillo, CA (US)

(72) Inventors: Jorn Huseby, Camarillo, CA (US); Bradley Pfeifer, Carmarillo, CA (US)

(21) Appl. No.: 13/874,988

(22) Filed: May 1, 2013

Related U.S. Application Data
(60) Provisional application No. 61/641,203, filed on May 1, 2012.

(51) Int. Cl. H04R 1/02

(52) U.S. Cl. CPC H04R 1/025
USPC 381/394

(57) ABSTRACT

A speaker system with an enclosure that has a rear wall, first and second side walls, first and second front walls, a top end and a bottom end. Each of the walls has upper and lower edges. The side walls are attached at right angles to the rear wall. The front walls have leading edges and trailing edges. The leading edges are joined at an acute angle and the trailing edges are attached to the side walls. The top end is attached to the upper edges and the bottom end is attached to the lower edges. At least three speakers are mounted to each of the rear wall and the first and second side walls. Wiring connects the speakers to connectors that provide connection to a signal source. The acute angle between the front walls is at least approximately 45 degrees and/or less than or equal to approximately 75 degrees.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### FIELD OF INVENTION

This disclosure relates to an enclosure with speakers and, more particularly to a speaker tower having a unique shape, cover material and design.

### BACKGROUND

Loudspeaker enclosures have one or more speakers mounted on them and are typically made of wood, wood composite or plastic. Besides mounting the speakers, enclosures help to prevent sound waves generated by the rearward-facing surface of the speaker driver from interfering with the sound waves generated by the forward-facing surface of the speaker driver. The forward- and rearward-generated sound waves are out of phase with each other because they are generated through opposite motion of the speaker diaphragm and because they travel different paths before converging at the listener's position. Interaction between the two waves can create distortions, echoes and reverberations.

Many loudspeaker enclosures use some sort of structure (usually a box) to contain the out-of-phase sound energy. Some enclosures are sealed and the rearward-generated sound waves are contained in the enclosure and dissipated, stopping the rearward-generated sound waves from interfering with the forward-generated waves. Another type of enclosure, ported enclosures, improve low-frequency output and increase efficiency by using cabinet openings or passive radiating elements to transform and transmit low-frequency energy from the rear of the speaker to the listener to complement and enhance the forward-generated waves.

It is an objective of the present invention to minimize or eliminate distortions, echoes and reverberations caused by out of phase sound wave interaction. It is a further objective to provide a true surround sound effect for realistic sound reproduction. It is still a further objective to provide a speaker system that can use a compact music storage system as an input source. It is yet a further objective to provide speaker enclosures adaptable to decoration with various finishes and visual patterns. Finally it is an objective of the invention to provide a speaker system that provide audiophile quality sound in a compact and attractive form factor.

### SUMMARY OF THE INVENTION

A speaker system meeting the above described objectives can be constructed from the following components. An enclosure is provided. The enclosure has a planar rear wall, first and second planar side walls, first and second planar front walls, a top end and a bottom end. Each of the walls has upper and lower edges. The side walls are attached orthogonally to the rear wall. The front walls have leading edges and trailing edges. The leading edges are joined at an acute angle and the trailing edges are attached to the side walls. The top end is attached to the upper edges and the bottom end is attached to the lower edges. At least three speaker drivers are provided. At least one of the speaker drivers is mounted to each of the rear wall, the first and second front walls. Wiring is provided. The wiring connects the speaker drivers to connectors. The connectors provide connection to a signal source.

In a variant of the invention, speaker system further includes a cover coupled to the enclosure.

In another variant, the cover includes suede material.

In still another variant, the cover includes micro-fiber synthetic suede material.

In yet another variant, the cover is further decorated with either of crystals and diamonds.

In a further variant, the cover has an animal design.

In still a further variant, the cover has a solid, high chroma color.

In yet a further variant, the cover is further decorated with either of crystals and diamonds.

In another variant of the invention, a first trim piece is provided. The first trim piece is located adjacent the top end and the upper edges. A second trim piece is provided. The second trim piece is located adjacent the bottom end and the lower edges.

In still another variant, the first trim piece and the second trim piece are chrome plated.

In yet another variant, the acute angle is approximately 65 degrees.

In a further variant, the acute angle is at least approximately 45 degrees and/or less than or equal to approximately 75 degrees.

In still a further variant, a first handle is provided. The first handle is coupled to the first trim piece. A second handle is provided. The second handle is coupled to the second trim piece.

In yet a further variant, the speaker driver mounted to the rear wall is a low frequency driver (woofer).

In another variant of the invention, the speaker driver mounted to the rear wall is a passive radiator.

In still another variant, the speaker driver mounted to each of the front walls is a mid-range speaker driver.

In yet another variant, at least one high frequency driver (tweeter) mounted to each of the rear wall and the first and second front walls.

In a further variant, a connector panel is provided. The connector panel has at least one of a power input connector, a sound input connector, and a sound output connector.

In still a further variant, an input connector for a media device is provided.

In yet a further variant, at least one of an infrared receiver and a LED function indicating light is provided.

In a final variant of the invention, a digital signal processor is provided.

### DESCRIPTION OF THE DRAWINGS

FIG. 1 is a rear perspective view illustrating a speaker tower.

FIG. 2 is a rear elevational view illustrating the speaker tower of FIG. 1.

FIG. 3 is a front elevational view illustrating the speaker tower of FIG. 1.

FIG. 4 is a right side elevational view illustrating the speaker tower of FIG. 1.

FIG. 5 is a left side elevational view illustrating the speaker tower of FIG. 1.

FIG. 6 is a top plan view illustrating the speaker tower of FIG. 1.

FIG. 7 is a bottom plan view illustrating the speaker tower of FIG. 1.

FIG. 8 is a close-up perspective view illustrating the media device connector, input signal & DSP mode selector & status LED's and volume knob on top of the speaker tower of FIG. 1.

FIG. 9 is a close-up perspective view illustrating the connector panel on the rear of the speaker tower of FIG. 1.

FIG. 10A is a rear perspective view illustrating a speaker tower with a first animal design.

FIG. 10B is a rear perspective view illustrating a speaker tower with a second animal design.

FIG. 10C is a rear perspective view illustrating a speaker tower with a third animal design.

FIG. 10D is a rear perspective view illustrating a speaker tower with a fourth animal design.

FIG. 10E is a rear perspective view illustrating a speaker tower with a fifth animal design.

### DETAILED DESCRIPTION

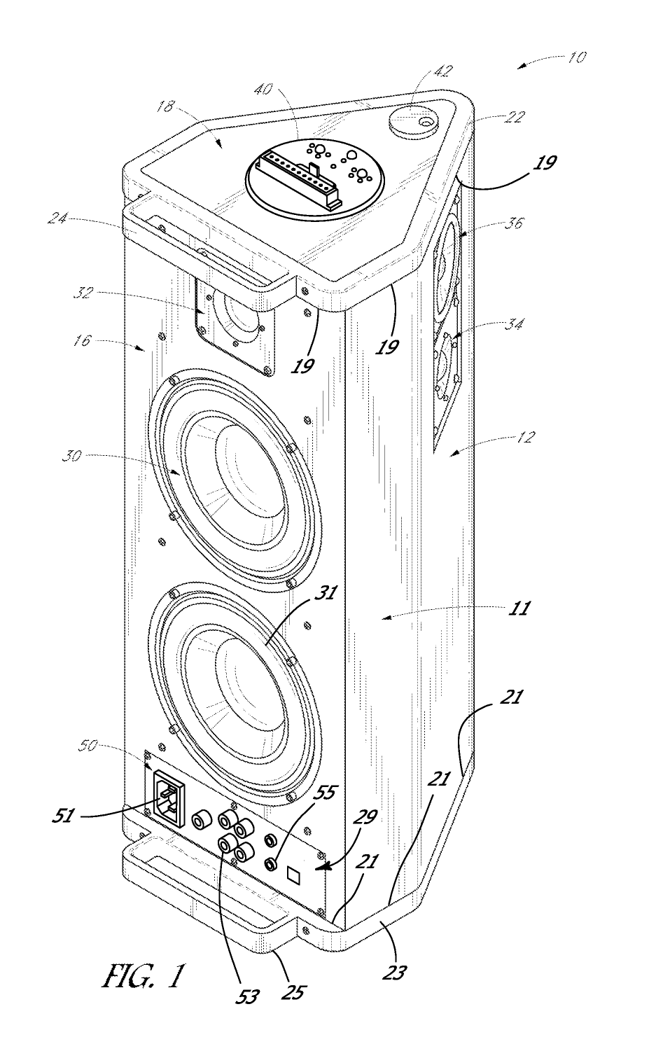

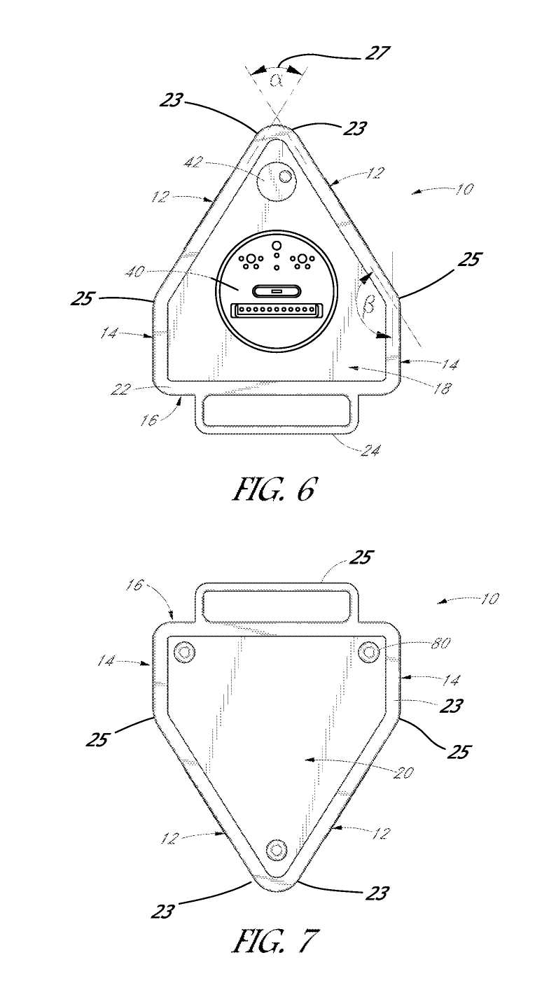

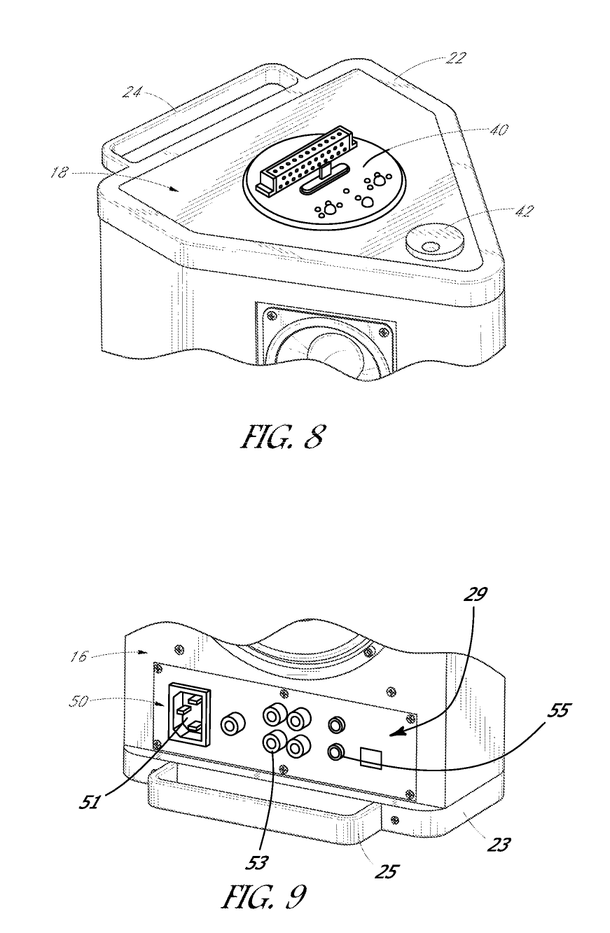

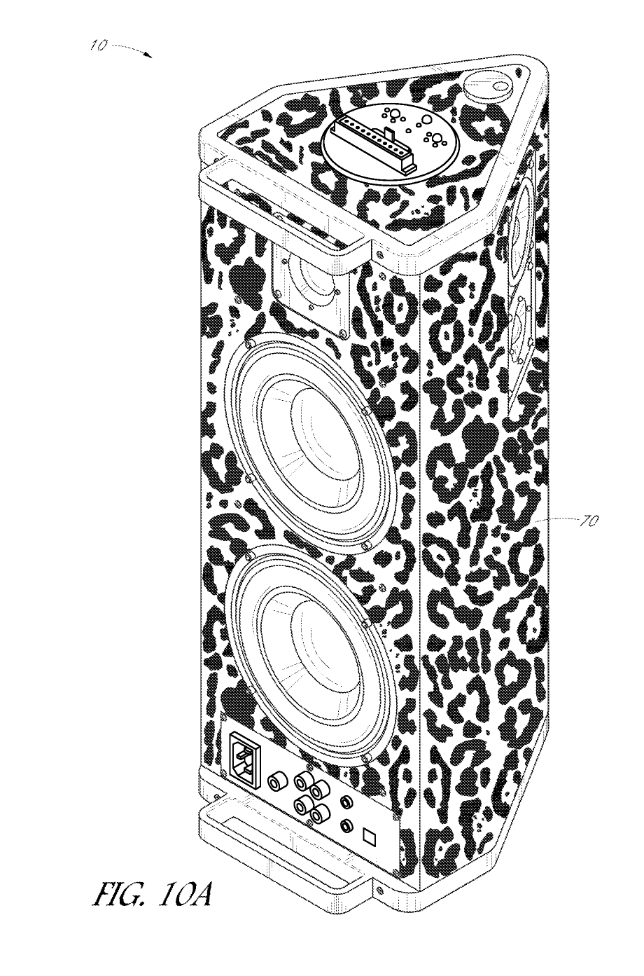

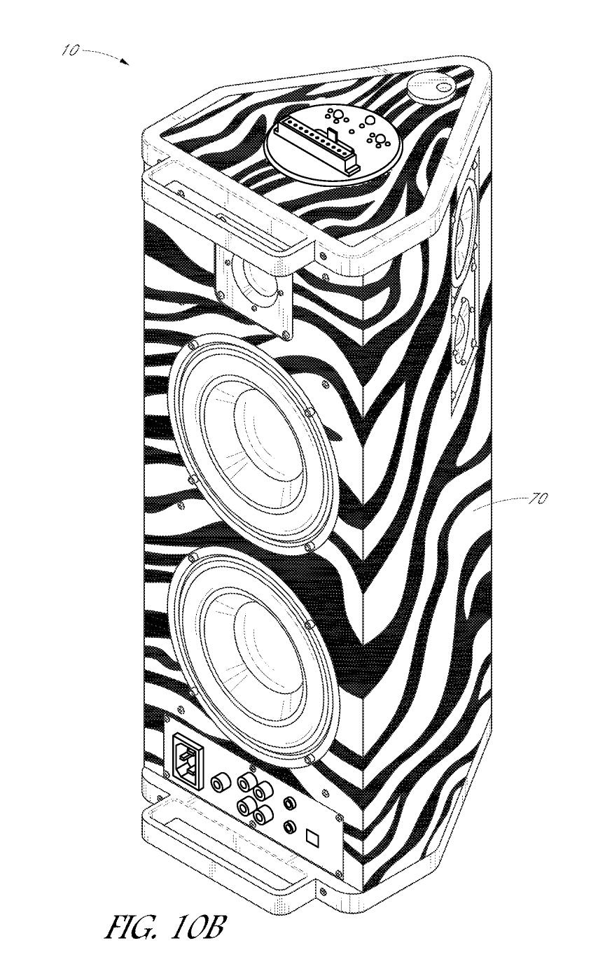

A speaker system 10 meeting the above described objectives can be constructed from the following components. As illustrated in FIGS. 1-5, an enclosure 11 is provided. The enclosure 11 has a planar rear wall 16, first and second planar side walls 14, first and second planar front walls 12, a top end 18 and a bottom end 20. Each of the walls 12, 14 and 16 has upper 19 and lower 2ledges. The side walls 14 are attached orthogonally to the rear wall 16. As illustrated in FIGS. 6 and 7, the front walls 12 have leading edges 23 and trailing edges 25. The leading edges 23 are joined at an acute angle 27 and the trailing edges 25 are attached to the side walls 14. The top end 18 is attached to the upper edges 19 and the bottom end 20 is attached to the lower edges 21. As illustrated in FIGS. 1-5, at least three speaker drivers 30, 34, 36 are provided. At least one of the speaker drivers 30, 34, 36 is mounted to each of the rear wall 16, the first and second front walls 12. Wiring (not shown) is provided. The wiring connects the speaker drivers 30, 34, 36 to connectors 29. The connectors 29 provide connection of the device to AC power source, internal amplifiers, DSP electronics and to input & output (I/O) signal sources (not shown).

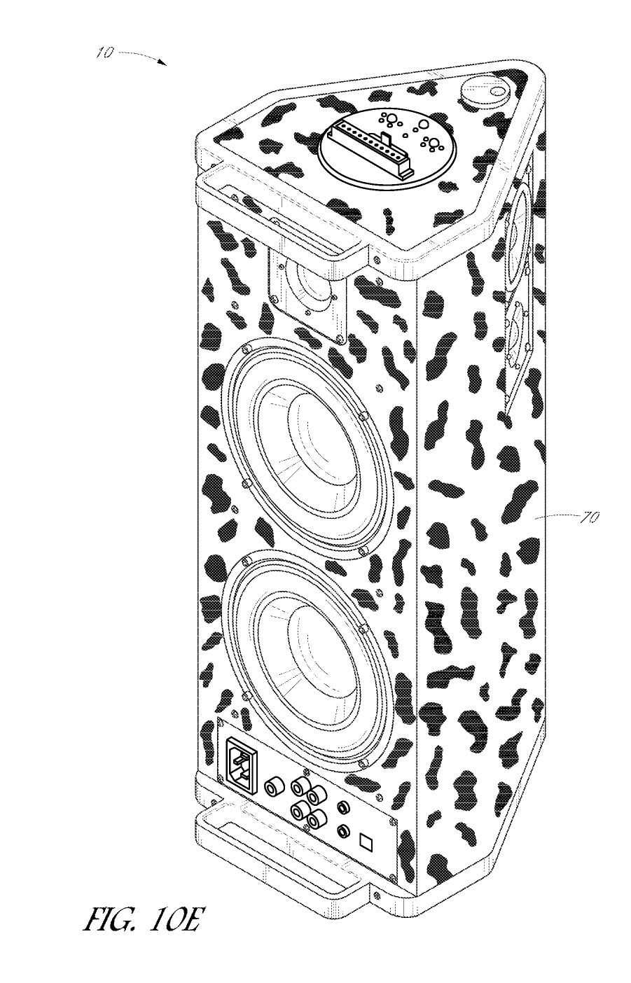

In a variant of the invention, as described in FIGS. 10A-10E, speaker system further includes a cover 70 coupled to the enclosure 11.

In another variant, the cover 70 includes suede material.

In still another variant, the cover 70 includes micro-fiber synthetic suede material.

In yet another variant, the cover 70 is further decorated with either of crystals and diamonds (not shown).

In a further variant the cover 70 has an animal design.

In still a further variant, the cover 70 has a solid, high chroma color (not shown).

In yet a further variant, the cover 70 is further decorated with either of crystals and diamonds (not shown).

In another variant of the invention, as described in FIGS. 1-9, a first trim piece 22 is provided. The first trim piece 22 is located adjacent the top end 18 and the upper edges 19. A second trim piece 23 is provided. The second trim piece 23 is located adjacent the bottom end 20 and the lower edges 21.

In still another variant, the first trim piece 22 and the second trim piece 23 are chrome plated.

In yet another variant, the acute angle 27 is approximately 65 degrees.

In a further variant, the acute angle 27 is at least approximately 45 degrees and/or less than or equal to approximately 75 degrees.

In still a further variant, a first handle 24 is provided. The first handle 24 is coupled to the first trim piece 22. A second handle 25 is provided. The second handle 25 is coupled to the second trim piece 23.

In yet a further variant, the speaker 30 mounted to the rear wall 16 is a low frequency driver (woofer).

In another variant of the invention, the speaker 31 mounted to the rear wall 16 is a passive radiator.

In still another variant, the speaker 36 mounted to each of the front walls 12 is a mid-range driver.

In yet another variant, at least one high frequency driver (tweeter) 34 is mounted to each of the rear wall 16 and the first and second front walls 12.

In a further variant, a connector panel 50 is provided. The connector panel 50 has at least one of a power input connector 51, a sound input connector 53, and a sound output connector 55.

In still a further variant, an input connector for a media device 40 is provided.

In yet a further variant, at least one of an infrared receiver 62 and a LED function indicating light 64 is provided.

In a final variant of the invention, a digital signal processor (not shown) is provided.

Speaker towers having unique shapes and designs are described herein. The speaker towers are hollow enclosures that can have four, five, six, seven, eight, or more side walls, as well as a top and bottom ends. In some embodiments, the speaker towers are elongate hollow enclosure with five sides, and top and bottom ends with a modified triangular shape. The modified-triangular shape is a generally triangle shape with two side extensions, such that there are five sides (i.e., pentagon) to the modified triangular shape, as illustrated in the figures. The widths of the walls of the speaker tower can vary. The speakers can be disposed on the walls, however, speakers on the top or bottom ends are also envisioned, such as downward or upward firing woofers. A speaker tower having desirable features and advantages will now be described with reference to the figures.

FIG. 1 illustrates a perspective view of a speaker tower 10 having five generally vertical walls and enclosed at the top and bottom. The speaker tower 10 comprises two front walls 12 facing the generally forward direction. Two side walls 14 face the generally left and generally right directions. A rear wall 16 faces toward the rear. The top is enclosed by a top end 18 and the bottom is enclosed by a bottom end 20. As illustrated in the figures, the intersections (i.e., corners) of the walls can be rounded or chamfered to enhance aesthetics and for easier installation of the cover, as discussed below.

The illustrated speaker tower 10 has an overall height of approximately 50 centimeters. In some embodiments, the overall height of the speaker tower can be at least approximately 25 centimeters and/or less than or equal to approximately 75 centimeters. The width of the speaker tower, from the left side to the right side, can be approximately 20 centimeters. In some embodiments, the width of the speaker tower can be at least approximately 10 centimeters and/or less than or equal to approximately 30 centimeters. In the illustrated embodiment, the depth of the speaker tower, from front to back, is approximately 25 centimeters. In other embodiments, the depth of the speaker tower can be at least approximately 10 centimeters and/or less than or equal to approximately 40 centimeters.

The walls and ends of the speaker tower 10 can be made of medium density fiberboard (MDF). A plurality of different types of material can also be used, such as plastic, metal, composites, or wood. Preferably, the thickness of the material is at least approximately 15 millimeters and/or less than or equal to approximately 25 millimeters. However, the thickness of the material can be at least approximately 6 millimeters and/or less than or equal to approximately 40 millimeters.

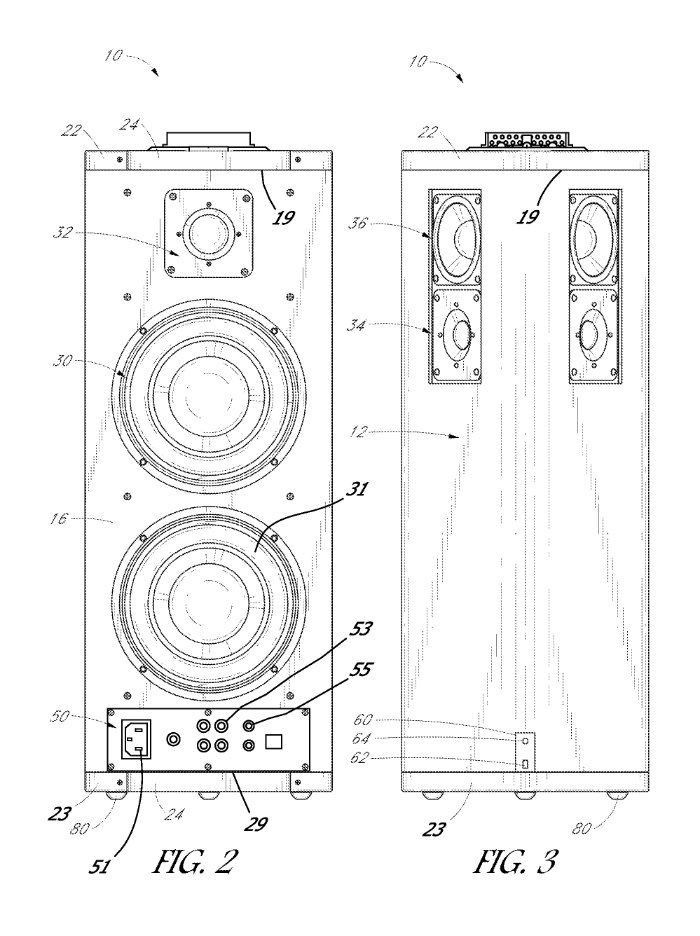

FIG. 2 shows the rear wall 16 of the speaker tower 10. In the illustrated embodiment, the rear wall 16 includes two woofers 30 that can produce low-range to mid-range sounds. Woofers produce low frequency sound waves, typically at least approximately 40 hertz and/or less than or equal to approximately one kilohertz (1 Khz), however, the woofers can produce sounds that have frequencies lower than 40 hertz and/or higher than one kilohertz. Low frequency sound waves are physically larger in size than mid & high frequency sound waves. The low frequency sound waves can travel further distances than mid or high frequency sound waves and as such, in many applications, the placement of low frequency woofers are less critical than the placement of mid or high frequency speaker drivers. Positioning the woofers 30 on the rear wall 16 of the speaker tower 10 advantageously allows the less critical low frequency sound waves from the woofers 30 to reflect and reverberate off building walls or other objects when the speaker tower 10 is placed near these objects, minimizing the overall sound degradation of the woofers 30. Although the speaker tower 10 can be placed near adjacent walls or other objects, the speaker tower 10 can also be placed in an open space, such as outdoors or on a stage with excellent results.

The rear wall 16 can include a tweeter 32 that is configured to produce high-range sounds. The high-range sounds can be at least approximately 2,000 hertz, (2 Khz) and/or less than or equal to approximately 20 kilohertz (20 Khz). In some embodiments the tweeters 32 can produce sounds that have frequencies lower than 2,000 hertz and/or higher than 20 kilohertz. As described below, the tweeter 32 on the rear wall 16 can be part of a triangular array design that produces a surround sound effect.

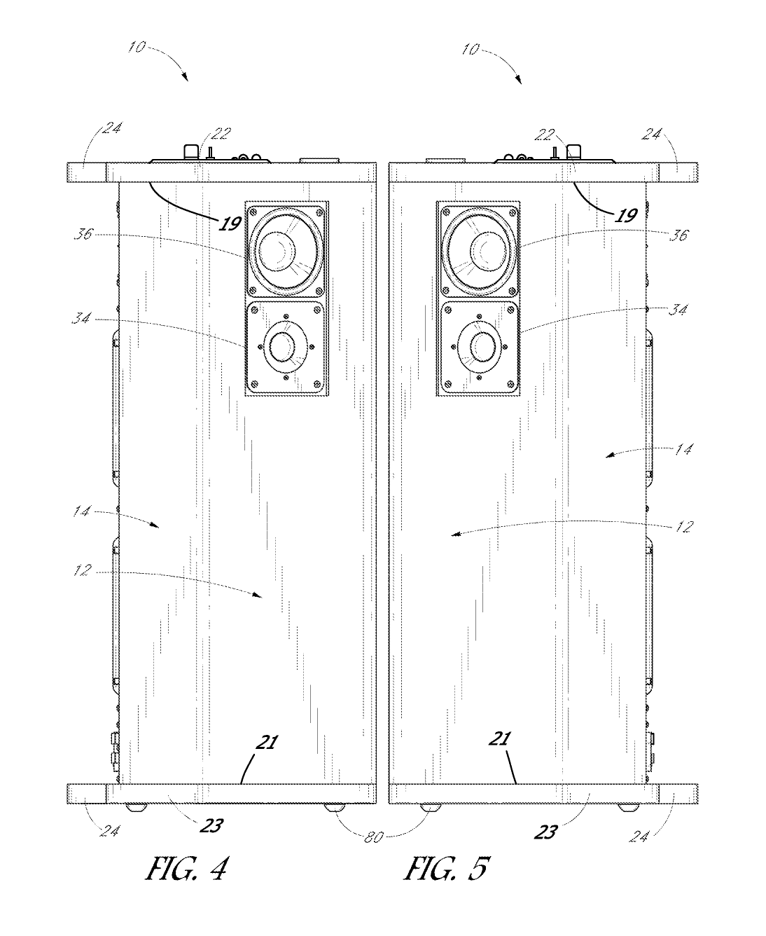

The rear wall 16 can have a screen (not shown) that is at least partially rigid to protect the speakers from dirt and damage. For example, the screen can be a metallic mesh having small holes for sonic transparency and can be configured to cover the speaker portions of the rear wall 16. In some embodiments, the screen can include a frame with a fabric or net over the frame that is permeable by sound. The frame can be made of a rigid plastic, metal, or wood. The screen can be held to the rear wall 16 by a plurality of different methods, such as fasteners, clips, adhesives, or magnets. For example, the rear wall 16 can have magnets secured or embedded in it and the metallic mesh can be held in place against the rear wall 16 by the magnetic attraction. With reference to FIGS. 3-6, the front walls 12 can be at an obtuse angle with respect to the side walls 14 such that the front walls 12 converge to a front edge 26 or vertex at the front of the speaker tower 10. The surfaces of the front walls 12 face away from each other and at least one speaker driver can be mounted on the surfaces of the front walls 12. Each wall 12 can have more than one speaker driver. In the illustrated embodiment, both front walls 12 have a tweeter 34 and midrange speaker driver 36 toward the upper portion of the front walls 12 that are generally centered in the width of the respective front walls 12. In some embodiments, the front walls 12 can have speaker drivers that are positioned at different locations on the front wall 12. For example, the front walls 12 can include woofers, or additional tweeters and midrange speaker drivers, toward the bottom portion of the front walls 12. In some embodiments, only one side of the front walls 12 may have speaker drivers.

The two tweeters 34 on the front walls 12—one on each front wall 12 of the speaker tower 10—and the rear tweeter 32 are arranged in a triangular driver array design, which allows high frequency sound to emit from the speaker tower 10 in three directions, producing triangular dispersion of the sound. Three is the minimum number of speaker drivers needed to form a “circular array” in order to produce a “surround sound” effect from a single-point source. Although it is possible to produce this surround sound effect with four (or more) speaker drivers in a criss-cross or square-quadrant (quad) design, utilizing three speaker drivers in a triangular array design accomplishes the task to approximately the same level of performance as the quad array, but at reduced production costs.

The two midrange speaker drivers 36 on the front walls 12 —one on each front wall 12 of the speaker tower 10—and the rear woofers 30 are arranged in a triangular driver array design. As stated above, the woofers 30 can produce mid-range sounds, which allow mid-range frequencies to emit from the speaker tower 10 in three directions, producing triangular dispersion of the sound, similar to the tweeters. The triangular array design can produce a “surround sound” effect from a single-point source.

The front walls 12 can have a screen (not shown) that has similar characteristics as described above for the rear wall screen. The screen can cover substantially the entire front walls 12, or cover just the speaker driver locations on the front walls 12.

The speaker drivers on the front walls 12 are directed away from each other, which advantageously enables the sound produced by the speaker drivers to diverge. The diverging sound from the front speaker drivers can disperse to provide a surround sound effect, as discussed above. The speaker drivers can be adapted to reduce interference and cancellation of sound waves between the speaker drivers on the left front wall and the speaker drivers on the right front wall, for example by phase shifting or phase adjusting one side of speaker drivers. In some embodiments, the use of suede or suede-like material covering can naturally absorb unwanted sound wave diffractions due to its unique surface texture and properties. Proprietary and complex DSP electronic circuits & algorithms can be employed to compensate for and fine tune the bass, mid and high frequency output with respect to the speaker drivers mounted on the front walls 12 and rear walls 16. Phase shift refers to the “time-alignment” of the sound waves with the goal of reaching the listener's ears all at the same time for the most natural and pleasing sound.

With continued reference to FIG. 6, the side walls 14 are at approximately a right angle with the rear wall 16. The extension provided by the side walls 14 effectively increases the interior volume of the speaker tower 10 which can help provide improved acoustics, especially with regard to the lower bass frequencies. Furthermore, the side walls 14 advantageously increase space in the interior to accommodate the large magnets on the woofers.

As stated above, the front walls 12 can be at an obtuse angle with respect to the side walls 14, as best illustrated by the angle β in FIG. 6. The angle between the two front walls 12 is angle α and is preferably approximately 65 degrees. In some embodiments, the angle α can be at least approximately 45 degrees and/or less than or equal to approximately 75 degrees. In some embodiments, the angle α can be at least approximately 30 degrees and/or less than or equal to approximately 90 degrees. Angle α is related to angle β by the relationship α=360°−2β. The angles α and dictate the directions that the speakers face on the front walls 12, which effects the sound characteristics of the speaker tower 10. For example, the facing directions of the front walls 12 are preferably optimized so that there is minimal cancellation of sound waves between the sound waves that emanate from the left front wall speakers and the sound waves that emanate from the right front wall speakers. Customizing the angle α also advantageously optimizes for a surround sound effect with a rich, balanced sound production. Various sound wave and phase/time align adjustments can be performed and employed with the use of advanced DSP electronics to further refine the sound output with respect to the front walls and the specified angle α.

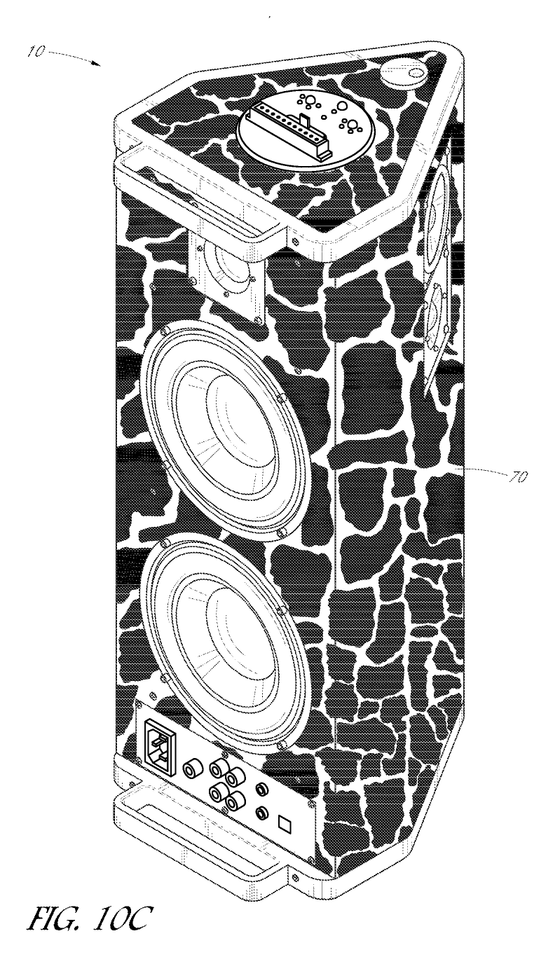

As illustrated in the close-up view of FIG. 8, the top end 18 of the speaker tower 10 can have a media device connector 40 to provide the input source for music or sounds. The media device connector 40 can be a proprietary connector, such as an Android® connector or the illustrated Apple® “MFI Lightning” dock connector. In some embodiments, the media device connector 40 can be a standard connector, such as, for example, RCA connectors, 3.5 mm jack, Universal Serial Bus (USB) connector, or optical connectors.

The speaker tower 10 can have a wireless receiver instead of, or in addition to, the connectors to receive input from a media source. For example, the speaker tower 10 can have a radio receiver to receive AM and FM radio stations. In another example, the speaker tower 10 can have a Bluetooth® receiver to accept signals from other Bluetooth® enabled devices, such as mobile phones and computers. In another example, the speaker tower 10 can include a wireless network adapter, such as a Wi-Fi® adapter to connect to other smart phone, media devices, computers or stream sounds directly from Internet sources.

With continued reference to FIG. 8, the speaker tower 10 can include a volume control 42 for adjusting the volume of the speakers. The volume control 42 can be a rotatable knob as illustrated in FIG. 8, which can use a digital encoder or analog potentiometer, or any of a plurality of different types of adjusters, such as a sliding adjuster, or up and down volume buttons. In some embodiments, the volume control can include a built-in on/off power control switch. In further embodiments, the volume can be controlled through an input touchscreen, as described below.

The speaker tower 10 can have a screen (not shown) that displays information, such as volume level, song information, battery level, clock, etc. The screen can be positioned on the top end 18, front walls 12, or side walls 14. In some embodiments, the screen can be a touch-screen that allows the user to select songs, change volume or otherwise input information to the speaker tower 10. The speaker tower 10 can include buttons used for inputting information in addition to, or instead, of the touch-screen.

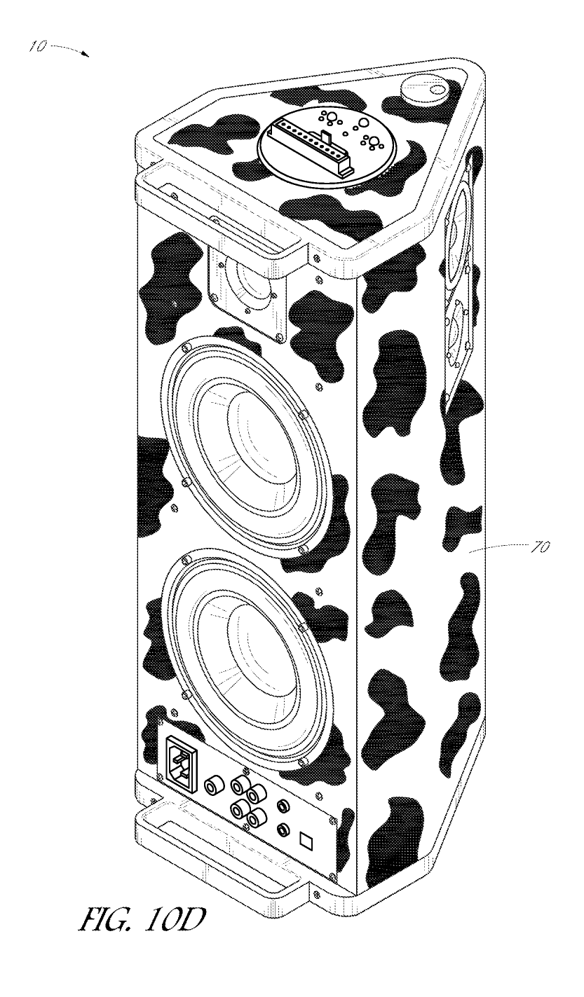

With reference to FIG. 9, the speaker tower can include a connector panel 50. Preferably, the connector panel 50 is positioned on the rear wall 16, but in some embodiments, at least some portions of the connector panel 50 can be positioned on other sides of the connector panel 50. The control panel 50 can include an electrical power input connector, such as the IEC input assembly shown in FIG. 9. The electrical power connector may include an on/off switch, (not shown) in the figure. The electrical power connector can be any type of electrical connector that can mate with a complementary connector on a power cord having a suitable power plug for the locality in which the speaker tower 10 is used.

The connector panel 50 can include hardware plugs or connectors as sound inputs and/or outputs. The plugs or connectors can be commonly used connector types, in both digital and/or analog format such as HDMI®, RCA, 3.5 mm jacks, etc., or can be a proprietary connector type for the speaker tower 10. For example, the connector panel 50 can have a group of RCA connectors for accepting 5.1 or 7.1 channel sound sources. The RCA connectors can include a left front channel, center channel, right front channel, left rear channel, right rear channel, and subwoofer channel. In some embodiments, a proprietary connector can be employed to “daisy-chain” or connect multiple speaker towers 10 together. In the illustrated embodiment of FIG. 9, the connector panel 50 has input and output connectors that can transfer analog & digital audio signals and data to and from a media device. The connector panel 50 includes two RCA analog audio input & output jacks for the left and right channels that are also included in the illustrated embodiment. The connector panel 50 also shows a ¼″ headphone output jack, two alternative 3.5 mm analog input & output jacks and a digital USB type B jack for digital data streaming and firmware upgrades.

The speaker tower 10 can have a front panel 60 that can have one or more of a display and receiver, as illustrated in FIG. 3. Preferably, the front panel 60 is located on the front walls 12 so that there is an unobstructed line of sight from a region in front of the speaker tower 10 to the front panel 60. In some embodiments, the front panel 60 can be positioned along the front edge 26 of the speaker tower 10. The front panel 60 can have an infrared (IR) receiver 62 to receive signals from a hand-held remote control device to remotely adjust the volume, song selection, or other function. The front panel 60 may also have a light, such as a light emitting diode (LED) 64 to indicate when the power to the speaker tower 10 is on. In some embodiments, more than one indicator light 64 can be included in the front panel 60. In some embodiments, the front panel 60 can have a screen that displays volume level, song information, battery level, clock, speaker tower 10 status, etc.

Inside the speaker tower 10 can be a controller unit (not shown) which controls and links the several components of the speaker tower 10. The controller unit can have a microprocessor to process the data from the media device or other media source, and convert the data to a digital signal for processing or to an analog output signal useable by the speakers. For example, the controller unit can include an analog-to-digital (ADC) converter that can convert analog output from popular device output formats (e.g., mp3, wma players) into digital signals. Once these signals are converted into digital format, they can be processed, manipulated and/or enhanced by any number of digital-based methodologies and/or DSP algorithms. Once the DSP is complete, a digital-to-analog (DAC) converter can be employed to convert the digital signals back into analog signals used by the speakers to produce sounds that can be heard and enjoyed by human ears. Thus, when an analog signal is inputted to the speaker tower 10, the controller unit can accept and process the analog signal for use by the speaker tower 10 in any number of ways. For example, a 5.1 channel audio signal can be processed and modified to a 2.1 channel audio signal for use by the speaker tower 10.

The controller unit can also process signals from the IR receiver and make adjustments to the volume, change songs, or other function depending on the remote control signal and/or remote control feature set. In embodiments having displays or screens, the controller unit can control the display and process the input signals from the screens.

Located inside the speaker tower 10 can also be an amplifier that changes the analog sound signals into voltages useable by the speakers to produce sounds. Many types of sound amplifiers that can be used in the speaker tower 10 are known by one of skill. There are both digital and analog type amplifiers that output a final analog signal used by speaker drivers to produce sounds that can be heard and understood by human ears and the human brain. Some amplifiers produce heat during operation and in some embodiments the amplifier can be in fluid communication with the environment surrounding the speaker tower 10 so that the amplifier can dissipate heat. The woofer drivers can employ special aluminum-alloy cones that can act as heat dissipation/heat reduction “pistons”. As the cones physically move back and forth to the audio voltage signal (forward and rear-ward motion) they act as air-cooling pistons with the rapid movement of air. The special aluminum-alloy is able to conduct and transfer heat from the inside of the speaker tower cabinet through to the outside of the cabinet. In addition, the aluminum-alloy woofer cones can advantageously be specially designed and “voiced” to have a customized musical timbre and tone, coupled with a very fast attack transient time. This fast attack (i.e., attack, decay, sustain and release or “ADSR” characteristics) aids in producing superior bass frequency “punch”, when properly configured, which adds realism to the lower frequency sound output. In some embodiments, the amplifier can be an integrated portion of the walls of the speaker tower 10 so that the enclosure of the amplifier is in direct contact with the surrounding environment for heat dissipation. The amplifier can have cooling fins to enhance the dissipation of heat. In some embodiments, a SMPS (switch mode power supply) amplifier design can be used, which uses no large or expensive power transformers and employs no heat sinks in the audio amplifier output stages. This results in very low heat build-up inside the cabinet and enables the electronic components to last longer in age due to the reduced heat, which can break down many electronic components over time.

The speaker tower 10 can be generally enclosed or sealed, which can help produce a controlled reproduction of sound by the speaker drivers, especially in the low-frequency range. In sealed enclosures, the rearward-generated sound waves are contained in the enclosure and dissipated, stopping the rearward-generated sound waves from interfering with the forward-generated waves. In some embodiments, the speaker tower 10 can be ported, or vented, which can improve low-frequency output, increase efficiency and make the effective volume of the enclosure larger. Ported enclosures improve low-frequency output and increase efficiency by using cabinet openings or passive radiating elements to transform and transmit low-frequency energy from the rear of the speaker to the listener to complement and enhance the forward-generated waves.

The top edge and bottom edge of the speaker tower 10 can have a trim 22, as illustrated in the figures. The trim 22 extends along the outer perimeter of the top end 18 and bottom end 20. Advantageously, the trim 22 can conceal the junction between the top end 18 and the walls 12, 14, 16, and the bottom end 20 and the walls 12, 14, 16. The trim 22 can add structural rigidity to the speaker tower 10 as well as provide corner-edge protection against impacts or damage to the speaker tower 10. Preferably, the trim 22 is sufficiently strong to support the weight of the speaker tower 10 when the tower is held by the handles, which are described below.

The trim 22 can be made of a metal material, such as aluminum or steel. In some embodiments, the trim 22 can be made of a rigid plastic material or a composite material, such as fiberglass. Various methods of manufacturing the trim can be utilized, such as vacuum molding, injection molding, CNC machining, extrusion, welding, etc.

The trim 22 can have a surface finish to enhance the aesthetics and provide a distinctive look. For example, the trim 22 can have a chrome-plated fmish. The trim 22 can have other appearances, such as a brushed aluminum finish, flat black finish, textured finish, or painted/anodized in any of a plurality of colors.

With continued reference to the figures, handles 24 can be attached to the speaker tower 10 for ease of transport. The handles 24 can have three sides that form a loop for easy carrying.

In the illustrated embodiments, the handles 24 have approximately the same height as the rear side of the trim 22 for an integrated and aesthetically pleasing appearance. However, the handles may have dimensions that differ from the trim's dimensions, such that the handles do not have an integrated appearance. In some embodiments, the handles can have other shapes, such as a semi-circular shape or have finger contours for an ergonomic fit. Advantageously, the handles 24 can provide some protection for the speakers and connector panel on the rear wall from damage.

Preferably, the handles 24 are molded or cut from the same piece of material as the trim 22 for high structural strength. The handles 24 can be welded or fastened to the trim 22, or to other parts of the speaker tower 10. For example, the handle can be attached to the left and right side walls 14. Preferably, the handles 24 have the same finish as the trim 22 for an integrated appearance. In some embodiments, the handles 24 can have a different finish, such as for example a textured or rubberized finish that helps improve gripping of the handle.

The exterior surface of the speaker tower 10 can be wrapped in a cover 70. The cover 70 can be attached to the exterior surface of the speaker tower 10 by any of a plurality of different methods, such as complex vacuum thermo-form & (heat) sheet-adhesive, general and special adhesives, staples, fasteners, clips, etc. Preferably, the cover 70 is attached to all the sides (i.e., front walls, side walls, rear wall, top end and bottom end). The entire speaker tower 10 can have a cover with a solid color, such as red, black, brown, blue, white, etc. In some embodiments, the speaker tower can have a cover with more than one color. For example, the walls of the speaker tower 10 can have a red cover while the top and bottom sides have a blue cover.

The cover 70 can be made of a suede material, which is a leather material with a napped finish, often made from the natural underside of the skin of animals, such as cows, lambs, goats, pigs, deer, etc. The soft composition of the suede material advantageously absorbs some vibrations of the speaker tower 10, helping reduce distortion and unwanted sound wave reflections and diffractions from the mounted speakers and their associated walls and baffles.

The cover 70 can enhance the structural rigidity of the speaker tower 10, helping to produce a tighter, clear sound from the speakers.

In some embodiments, non-woven, micro-fiber, synthetic man-made suede made via complex and/or proprietary manufacturing methods can be used. In other embodiments, any of a wide variety of materials can be used to cover the speaker tower, such as for example criss-cross stitched or “tuck and rolled” padded leather or vinyl, or printed or embroidered or non-embroidered denim, wool fabric, cotton fabric, miscellaneous fabrics, felt, plastic or design-printed plastic, foam, rubber, composites, wood, glass or colored-glass, ceramics, etc. The speaker tower 10 is not limited to traditional wood or wood-related or automotive-grade painted outer coverings. The outer covering is meant to be an art form or fashion-forward design covering; creating a paradigm shift in the manner in which we normally envision speaker cabinets and enclosures.

The cover, especially suede covers, can be embossed with designs or customer logos. For example, a suede cover can have raised portions or depressed portions that are in a customer's recognized logo pattern so that the logo can be distinguished on the suede cover. The embossed portions having the design or logo can have colors that are different than the rest of the cover to further distinguish the design or logo and make it more visible.

In some embodiments, the cover 70 can have an animal pattern. FIGS. 10A-10E illustrate some examples of speaker towers 10 having an animal pattern cover. The animal pattern can be for a cheetah, zebra, giraffe, cow, tiger, etc., and made from a variety of materials that allow for animal prints to be employed on the surface of the material. Some examples include engineered wood or wood composites, micro-fiber and/or man-made suede, various traditional fabrics, injection molded plastic and printed or painted plastic in all forms (sheet, injection molded etc). The examples shown in the figures are for illustrative purposes, and the types of animal patterns should not be limited to the patterns in FIGS. 10A-10E.

In some embodiments, the cover 70 can have print designs or logos, similar to described above for the embossed cover, but printed instead of embossed. The design or logo can be printed on almost any cover material (e.g., suede, micro-fiber ultra suede, traditional fabrics, etc.) and can include complex designs, such as pictures of cartoon characters, musical band logos, sports teams etc.

Crystals, diamonds, or other jewels can be attached to the cover for a decorative effect. The jewels can be real, or fake jewels made from plastic or glass. The cover can have other decorative items attached, such as beads, strings, glitter, decorative tissue paper, or any of a plurality of different types of decorative adornments.

With reference to FIG. 7, the bottom end 20 of the speaker tower 10 can have feet 80. The feet 80 can be made of a non-slip material, such as rubber, that help secure the speaker tower 10 on surfaces, particularly slippery surfaces. The feet 80 are preferably compliant and can absorb vibrations and reduce distortions of the speakers. In the illustrated embodiment, the feet 80 are three semi-round pieces fastened to the bottom end 20. In other embodiments, there can be more than three feet pieces and can be in a variety of shapes and sizes.

The speaker tower 10 can include brackets (not shown) to enable mounting the speaker tower onto a wall. For example, brackets that are configured to mount to a wall will preferably attach to the bottom end 20 of the speaker tower 10. The brackets can be adjustable so that the speaker tower 10 can swivel or rotate, and/or tilt (e.g., angled up or down) on the bracket. In some embodiments, a bracket can attach to the trim 22 or the handles 24.

In some embodiments, a pair of speaker towers can be mounted on brackets and adjusted to customize the speaker pair sound characteristics for a given room configuration. For example, a pair of speaker towers can be mounted to the left and right side of a large screen TV. The speaker towers can be physically adjusted to “dial-in” the exact degree of longitudinal on-axis or off-axis tilt for desired sound projection from each cabinet, to achieve the best suited sound for the given acoustics of the listener's room and environment. Since all rooms have different acoustic challenges, this feature allows the user to make physical changes in the speaker tower positions from the adjustable brackets to obtain a sound that is most pleasing to the user with or without the aid of complex DSP electronics.

For example, in some embodiments, the user can tilt-adjust the left-mounted speaker tower to output mostly left front output of sound in a pleasing manner and perform the same procedure for the right-mounted speaker tower. This adjustability is not possible with traditional speakers since they do not radiate sound in a circular, triangular or surround-sound array. Advantageously, the multiple sided array of speaker drivers on the speaker tower 10 allows for acoustical reflections based upon the listener's room acoustics that can add depth and realism to the musical presentation and soundstage of the audio content delivered.

Throughout this description, the embodiments and examples shown should be considered as exemplars, rather than limitations on the apparatus and procedures disclosed or claimed. Although many of the examples presented herein involve specific combinations of method acts or system elements, it should be understood that those acts and those elements may be combined in other ways to accomplish the same objectives. Acts, elements and features discussed only in connection with one embodiment are not intended to be excluded from a similar role in other embodiments. Additionally, it will be recognized that the methods described herein may be practiced in different sequences, and/or with additional devices as desired. Such alternative embodiments and/or uses of the methods and devices described above and obvious modifications and equivalents thereof are intended to be included within the scope of the present invention. Thus, it is intended that the scope of the present invention should not be limited by the particular embodiments described above, but should be determined only by a fair reading of the claims that follow.

1. A speaker system comprising:
an enclosure, said enclosure having a planar rear wall, first and second planar side walls, first and second planar front walls, a top end and a bottom end;
each of said walls having upper and lower edges;
said side walls being attached orthogonally to said rear wall;
said front walls having leading edges and trailing edges, said leading edges being joined at an acute angle and said trailing edges being attached to said side walls;
said top end being attached to said upper edges and said bottom end being attached to said lower edges;
at least three speakers, at least one of said speakers being mounted to each of said rear wall, said first and second front walls; and
wiring, said wiring connecting said speakers to connectors, said connectors providing connection to a signal source.

2. The speaker system, as described in claim 1, further comprising a cover coupled to said enclosure.

3. The speaker system of as described in claim 2, wherein the cover comprises suede material.

4. The speaker system of as described in claim 2, wherein said cover comprises micro-fiber synthetic suede material.

5. The speaker system of as described in claim 3, wherein said cover is further decorated with either of crystals and diamonds.

6. The speaker system of as described in claim 2, wherein said cover has an animal design.

7. The speaker system of as described in claim 2, wherein said cover has a solid, high chroma color.

8. The speaker system of as described in claim 7, wherein said cover is further decorated with either of crystals and diamonds.

9. The speaker system of as described in claim 1, further comprising:
a first trim piece, said first trim piece being disposed adjacent said top end and said upper edges; and
a second trim piece, said second trim piece being disposed adjacent said bottom end and said lower edges.

10. The speaker system as described in claim 9, wherein said first trim piece and said second trim piece are chrome plated.

11. The speaker system as described in claim 1, wherein said acute angle is approximately 65 degrees.

12. The speaker system as described in claim 1, wherein said acute angle is at least approximately 45 degrees and/or less than or equal to approximately 75 degrees.

13. The speaker system as described in claim 9, further comprising:
a first handle, said first handle being coupled to said first trim piece; and
a second handle, said second handle being coupled to said second trim piece.

14. The speaker system as described in claim 1, wherein said speaker mounted to said rear wall is a low frequency driver (woofer).

15. The speaker system as described in claim 1, wherein said speaker mounted to said rear wall is a passive radiator.

16. The speaker system as described in claim 1, wherein said speaker mounted to each of said front walls is a mid-range driver.

17. The speaker system as described in claim 1, further comprising at least one high frequency driver (tweeter) mounted to each of said rear wall and said first and second front walls.

18. The speaker system as described in claim 1, further comprising a connector panel, said connector panel having at least one of a power input connector, a sound input connector, and a sound output connector.

19. The speaker system as described in claim 18, further comprising an input connector for a media device.

20. The speaker system as described in claim 18, further comprising at least one of an infrared receiver and a LED function indicating light.

21. The speaker system as described in claim 18, further comprising a digital signal processor.
